(19) United States
(12) Patent Application Publication
(10) Pub. No.: US 2026/0121015 A1
(43) Pub. Date: Apr. 30, 2026

(54) METHODS FOR MAKING SOLID-STATE LITHIUM-ION BATTERIES

(71) Applicant: Graphenix Development, Inc., Williamsville, NY (US)

(72) Inventors: Alexander J. Warren, Lake View, NY (US); Terrence R. O’Toole, Webster, NY (US); Robert G. Anstey, Tonawanda, NY (US); John C. Brewer, Rochester, NY (US)

(73) Assignee: Graphenix Development, Inc., Williamsville, NY (US)

(21) Appl. No.: 19/148,539

(22) PCT Filed: Feb. 13, 2024
(86) PCT No.: PCT/US2024/015578

§ 371 Date: Jul. 16, 2025

Related U.S. Application Data
(60) Provisional application No. 63/484,847, filed on Feb. 14, 2023.
(60) Provisional application No. 63/607,211, filed on Dec. 7, 2023.

(51) Int. Cl. H01M 4/04; H01M 10/04; H01M 10/0525

(52) U.S. Cl. CPC H01M 4/0445; H01M 10/0468; H01M 10/0525

(57) ABSTRACT

A method for making a lithium-ion battery includes constructing a precursor cell having an anode, a cathode and a solid-state electrolyte (SSE). The anode includes a silicon-containing lithium storage layer deposited onto an anode current collector by a CVD or PVD process. The cathode includes a cathode active material layer in contact with a cathode current collector. The SSE is interposed between the lithium storage layer and the cathode active material layer. The precursor cell is electrochemically treated by applying at least a first voltage cycle between the anode and cathode to cause at least a partial charging of the anode, and subsequently, at least a partial discharging of the anode. The precursor cell is heated to a temperature T₁ of at least 40° C., and after heating, the cell is cooled to a temperature below T₂ to produce the lithium-ion battery, wherein T₂ is less than T₁.

### CROSS-REFERENCES TO RELATED APPLICATIONS

This application claims the benefit of priority of U.S. Provisional Application No. 63/484,847, filed Feb. 14, 2023, and U.S. Provisional Application No. 63/607,211, filed Dec. 7, 2023, each of which is incorporated herein by reference in its entirety.

### STATEMENT AS TO RIGHTS TO INVENTIONS MADE UNDER FEDERALLY SPONSORED RESEARCH AND DEVELOPMENT

This invention was made with government support under Contract No. W911NF2220021 awarded by the U.S. Army. The government has certain rights in the invention.

### TECHNICAL FIELD

The present disclosure relates to solid-state lithium-ion batteries and related energy storage devices.

### BACKGROUND OF THE INVENTION

Silicon has been proposed for lithium-ion batteries to replace the conventional carbon-based anodes, which have a storage capacity that is limited to ˜370 mAh/g. Silicon readily alloys with lithium and has a much higher theoretical storage capacity (˜3600 to 4200 mAh/g at room temperature) than carbon anodes. Besides improved energy storage density, silicon-based anodes may also provide additional safety benefits, e.g., more robust performance against the well-known “nail penetration test”. To further improve the safety of lithium-ion batteries, work is also ongoing to replace electrolytes based on volatile small molecule solvents with safer solid-state electrolytes.

Unfortunately, insertion and extraction of lithium into a silicon matrix can cause significant volume expansion (>300%) and contraction. This can result in rapid pulverization of the silicon into small particles and electrical disconnection from the current collector. The expansion and contraction of silicon-containing anodes pose additional challenges for making solid-state battery cells. With such volume changes, it can be difficult to maintain functionally sufficient physical contact between the anode active material and the solid-state electrolyte.

Despite research into various approaches, batteries based primarily on silicon, particularly those using solid-state electrolytes, have yet to make a large market impact due to unresolved problems.

### BRIEF SUMMARY OF THE INVENTION

There remains a desire for solid-state lithium-ion batteries based on silicon anodes that are easy to manufacture, safer, robust to handling, high in charge capacity, amenable to fast charging, and have good cycle life.

In accordance with an embodiment of this disclosure, a method for making a lithium-ion battery includes constructing a precursor cell having an anode, a cathode and a solid-state electrolyte (SSE). The anode includes a silicon-containing lithium storage layer deposited onto an anode current collector by a CVD or PVD process. The cathode includes a cathode active material layer in contact with a cathode current collector. The SSE includes lithium ions and is interposed between the lithium storage layer and the cathode active material layer. The method further includes electrochemically treating the precursor cell by applying at least a first voltage cycle between the anode and cathode to cause at least a partial charging of the anode, and subsequently, at least a partial discharging of the anode. The precursor cell is heated to a temperature T₁ of at least 40° C., and after heating, the cell is cooled to a temperature below T₂ to produce the lithium-ion battery, wherein T₂ is less than T₁.

### BRIEF DESCRIPTION OF THE DRAWINGS

FIG. 1A is a cross-sectional view of a non-limiting example of a precursor cell according to some embodiments.

FIG. 1B is a cross-sectional view of a non-limiting example of an anode according to some embodiments.

FIG. 1C is a cross-sectional view of a non-limiting example of a lithium-ion battery cell according to some embodiments.

FIG. 1D is top view of a non-limiting example of a segmented lithium storage layer according to some embodiments.

FIG. 1E is a cross-sectional view of a non-limiting example of a segmented lithium storage layer according to some embodiments.

FIG. 2 is a cross-sectional view of a prior art anode.

FIGS. 3A and 3B are cross-sectional views illustrating a non-limiting example of making a precursor cell.

FIG. 3C is a cross-sectional view of another non-limiting example of making a precursor cell according to some embodiments.

FIGS. 3D and 3E are cross-sectional views of another non-limiting example of making a precursor cell according to some embodiments.

FIG. 4A is a cross-sectional view of a non-limiting example of a precursor cell according to some embodiments.

FIG. 4B is a cross-sectional view of a non-limiting example of a lithium-ion battery cell according to some embodiments.

### DETAILED DESCRIPTION OF THE INVENTION

It is to be understood that the drawings are for purposes of illustrating the concepts of the disclosure and may not be to scale. Terms like “overlaying”, “over” or the like include, but do not necessarily require, direct contact (unless such direct contact is noted or clearly required for functionality). Herein, an “average” may represent a mean, median, or mode, and an “average thickness” may be based on at least three measurements. Additional details of certain embodiments of the present application may be found in U.S. Patent Application Publication No. 2019/0267631, U.S. Patent Application Publication No. 2020/0411851, U.S. Patent Application Publication No. 2021/0050584, U.S. Patent Application Publication No. 2021/0057733, U.S. Patent Application Publication No. 2021/0057757, U.S. Patent Application Publication No. 2021/0057755, U.S. Patent Application Publication No. 2021/0066702, PCT International Publication Number WO2022/005999, PCT International Publication Number WO2021/207357, PCT International Publication Number WO2023/113813, U.S. Patent Application Publication No. 2022/0344627, PCT Internation Publication Number WO2023/129408, PCT International Application No. PCT/US2023/024254, and PCT International Application Number PCT/US23/25773, the entire contents of which are incorporated herein by reference for all uses.

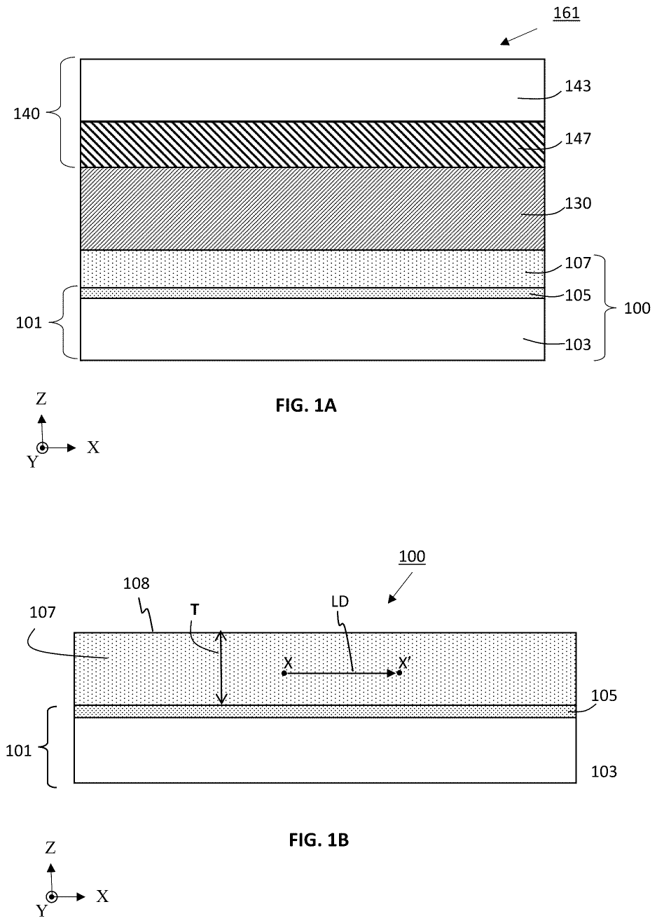

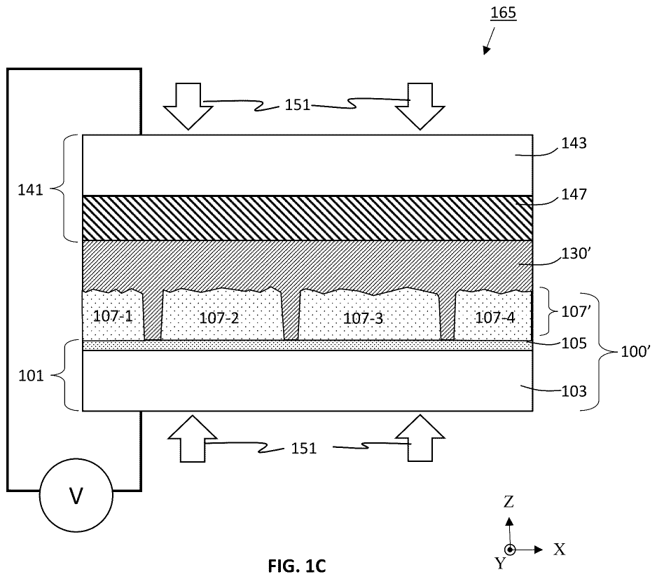

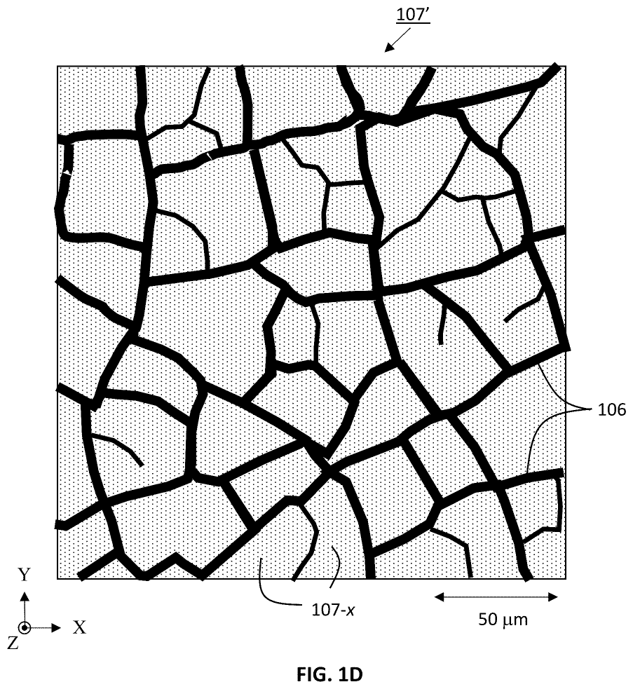

Lithium-ion batteries (LIBs) of the present disclosure may include a silicon-containing anode, a solid-state electrolyte (“SSE”), and a cathode. In some embodiments, an LIB may be made by heating a precursor cell. FIG. 1A is a cross-sectional view of a precursor cell according to some embodiments. For additional reference, XYZ coordinate axes are also provided. Precursor cell 161 includes anode 100, a cathode 140, and a solid-state electrolyte 130 disposed between the anode and the cathode. Anode 100 may include an anode current collector 101 and a lithium storage layer 107. Cathode 140 may include a cathode current collector 143 and a cathode active material layer 147 disposed in contact with the cathode current collector facing the lithium storage layer 107. The solid-state electrolyte includes lithium ions and at least a portion of the SSE is reversibly transformable from a low flowability state (e.g., a glassy or solid state) below a temperature T₂ to a high flowability state (e.g., a fluid or liquid state) at or above a temperature T₁ without degrading the desired properties of the SSE. Temperature T₁ is generally at least 40° C. and T₁ is equal to or greater than T₂. More details on the above components are discussed below.

Anode 100 is further described in FIG. 1B (also a cross-sectional view) and may include a current collector 101 and a lithium storage layer 107 overlaying the current collector. In some cases, the lithium storage layer may be a silicon-containing lithium storage layer. The lithium storage layer is capable of forming an electrochemically reversible alloy with lithium. The current collector may include an electrically conductive layer 103 and may further include a surface layer 105 disposed between the electrically conductive layer 103 and the lithium storage layer 107. In some embodiments, the lithium storage layer may include silicon, germanium, tin, or alloys thereof. In some embodiments the lithium storage layer is a silicon-containing lithium storage layer including at least 40 atomic % silicon. In some embodiments, lithium storage layer 107 may be prelithiated as discussed elsewhere herein.

In some embodiments, the top of the lithium storage layer 107 corresponds to a top surface 108 of anode 100. Lithium storage layer 107 may in some cases be characterized by an average thickness T (e.g., mean, median, or mode). The lithium storage layer 107 is in electrical and physical contact with the current collector 101. Although the figures show the surface of the current collector as flat for convenience, the current collector may have a rough surface as discussed below. In some embodiments, the lithium storage layer is provided by a physical vapor deposition (PVD) process, e.g., by sputtering or e-beam, or by a chemical vapor deposition (CVD) process including, but not limited to, hot-wire CVD or a plasma-enhanced chemical vapor deposition (PECVD). In some embodiments, lithium storage layer 107, or portions thereof, may include a continuous porous lithium storage layer. PVD and CVD deposition methods are highly manufacturable since they may avoid the many extra steps involved in conventional binder-based (particulate) lithium storage layers. The lithium storage layer may be relatively flat which may in some cases make it more robust to handling and compatible with other manufacturing processing relative to, e.g., anodes made with binders, particulates, or high aspect-ratio nanostructures, which may more easily break or flake off. For example, coating an SSE over a PVD-or CVD-deposited lithium storage layer may be more robust than deposition over nanostructured or particulate lithium storage layers.

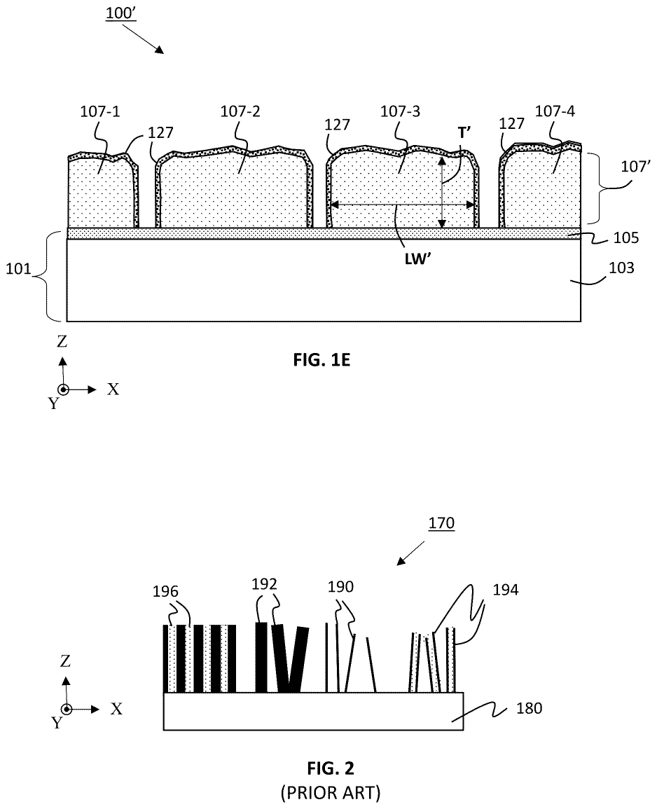

In the present disclosure, the lithium storage layer 107, such as a continuous porous lithium storage layer, may be substantially free of high aspect ratio lithium storage nanostructures, e.g., in the form of spaced-apart wires, pillars, tubes or the like, or in the form of regular, linear vertical channels extending through the lithium storage layer. FIG. 2 shows a cross-sectional view of a prior art anode 170 that includes some non-limiting examples of high aspect ratio lithium storage nanostructures, such as nanowires 190, nanopillars 192, nanotubes 194 and nanochannels 196 provided over a current collector 180. Unless noted otherwise, the term “lithium storage nanostructure” herein generally refers to a lithium storage active material structure (for example, a structure of silicon, germanium, or their alloys) having at least one cross-sectional dimension that is less than about 2,000 nm, other than a dimension approximately normal to an underlying substrate (such as a layer thickness) and excluding dimensions caused by random pores and channels. Similarly, the terms “nanowires,” “nanopillars,” and “nanotubes” refers to wires, pillars, and tubes, respectively, at least a portion of which, have a diameter of less than 2,000 nm. “High aspect ratio” nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the lithium storage layer, e.g., a continuous porous lithium storage layer, is considered “substantially free” of high aspect ratio lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. In some embodiments, an anode may have patterned regions of lithium storage layer 107 and other regions that may purposefully include lithium storage nanostructures. In such cases, the term “substantially free” may refer just to a particular region of the lithium storage layer. As noted below, the current collector may have a high surface roughness or include nanostructures, but these features are separate from the lithium storage layer and not considered to be or induce lithium storage nanostructures.

In some embodiments and referring now to FIG. 1C (also a cross-sectional view), the anode and cathode current collectors may be connected to a voltage source (V) and the precursor cell may undergo one or more charge/discharge cycles which may also be referred to herein as one or more voltage cycles. A voltage cycle may include application of a relatively negative voltage (first voltage) to the anode to cause at least partial lithiation of the anode followed by application of a relatively positive voltage (second voltage) to cause at least partial delithiation of the anode. This may be referred to as electrochemical formation or treatment, and represents cycling conducted prior to normal-use cycling of the finished cell functioning as a battery. Note that herein, when describing such initial cycling of the anode or cell, terms such as “electrochemical formation”, “electrochemically forming” or the like may be interchanged with “electrochemical treatment” or “electrochemically treating” or the like. During electrochemical treatment the precursor cell may be heated to a temperature Ti so that the SSE is transformed to a high flowability state. A pressure 151 may optionally be applied during the heating such that the lithium storage layer and cathode active material layer press against the SSE. During electrochemical treatment, it has been found that silicon-containing lithium storage layers, for example, continuous porous lithium storage layers, tend to reconstitute as a segmented lithium storage layer. Unlike pulverization where much of the silicon becomes unusable, the segmented lithium storage layer maintains high lithium-storage activity. While not being bound by theory, it may be that anodes of the present disclosure expand primarily (not necessarily solely) in a Z direction during lithiation, and upon delithiation, it may contract in the Z direction and also in the X-Y plane so that the anode active material is reconstituted as a segmented lithium storage layer. As a result, a segmented lithium storage layer 107′ is produced including lithium storage segments 107-1, 107-2, 107-3, and 107-4. Note that the segments are not herein considered nanostructures (e.g., the height aspect ratios of the lithium storage layer segments are generally less than 4:1). The heating allows the SSE material, now in its high flowability state, to flow into spaces between the lithium storage segments to form a modified SSE layer 130′. The SSE of the precursor cell should be provided in sufficient volume to fill the segment spaces and still maintain physical separation of the cathode active material from the segmented lithium storage layer 107′. In some embodiments, a lithium-ion conductive current separator (discussed elsewhere) may be added to ensure no contact between the anode and cathode while the SSE is in its high flowability state.

Upon cooling to below temperature T₂, the SSE transforms back from its high flowability state to a low flowability state, e.g., to become glassy or solid and lock in the structure of lithium-ion battery cell 165. In some cases, after cooling, the pressure 151 (if used) may be reduced or eliminated, but in some embodiments, applied pressure 151 may be maintained or even increased. Relative to the precursor cell 161 FIG. 1A, the top of the lithium storage layer 107′ and the bottom of the cathode active material layer 147 in LIB cell 165 may be more closely spaced. For example, the spacing may be 5% to 10%, 10% to 15%, 15% to 20%, 20% to 25%, or over 25% closer. FIG. 1D a is top view of a non-limiting example of a segmented lithium storage layer 107′ including a plurality lithium storage segments 107-x and where the dark lines 106 represent the segment spaces. For clarity, other lithium-ion battery components are not shown. In some embodiments, segment spaces may account for 1-5% of the anode surface area (e.g., from a 2-dimentional top-down view), alternatively 5-10%, 10-15%, 15-20%, or 20-25% of the surface area. In some embodiments, the width of segment spaces may be in a range of 10-20 nm, 20-50 nm, 50-100 nm, 100-200 nm, 200-300 nm, 300-500 nm, 500-700 nm, 700 nm-1 μm, 1-2 μm, 2-3 μm, 3-5 μm, 5-7 μm, 7-10 μm, 10-12 μm, 12-15 μm, 15-20 μm, or any combination of ranges thereof, In some cases, e.g., when measured across a 1 mm cross-section distance of the anode, the sum of individual spaces S may account for a total of 1-5% of the cross-section distance, alternatively 5-10%, 10-15%, 15-20%, 20-25%, 25-30%, 30-35%, or 35-40% of the cross-section distance, or any combination of ranges thereof. The segment spaces and/or cross-section distance may, e.g., be measured at about 50% of the average thickness of the storage layer segments.

FIG. 1D illustrates a generally random pattern of lithium storage segments. In some other embodiments (not illustrated), the pattern may be more uniform or even partially or fully predetermined.

In some embodiments, rather than heating to Ti during electrochemical treatment, heat may be applied afterwards so that the SSE in its high flowability state may flow into the spaces between segments. Regardless of whether heat is applied during or after electrochemical treatment, in some embodiments, a completed battery cell may have normal operating conditions such that the SSE generally stays in a lower flowability state. That is, during normal use (charging and discharging), the SSE does not transform to a higher flowability state.

FIG. 1E is another cross-sectional view illustrating the anode 100′ formed as described with respect to FIG. 1C. FIG. 1E may be otherwise like FIG. 1C, but for clarity, the SSE and cathode are not illustrated in FIG. 1E. An SEI (“Solid-Electrolyte-Interphase”) layer 127 may be formed over the lithium storage layer segments. An SEI layer may be formed during electrochemical cycling by partial decomposition or reaction of the SSE. The SEI is generally electrically insulating but ionically conductive, thereby allowing lithium ions to pass through. The SEI may lessen decomposition of the SSE in later electrochemical cycling.

FIG. 1E also illustrates some of the dimensional properties that the segmented storage layer may take. In some embodiments, for the majority of lithium storage segments within at least one 1 mm by 1 mm area of the anode, a ratio of the average lateral width LW′ of a lithium storage layer segment to the average thickness T′ of the lithium storage layer segment, i.e., the ratio of LW′/T′ may be at least 0.3. In some embodiments, such ratio of LW′/T′ may be less than 50. In some embodiments, the ratio of LW′/T′ may be in a range of 0.3-0.4, alternatively 0.4-0.5, alternatively 0.5-0.75, alternatively 0.75-1.0, alternatively 1.0-1.5, alternatively 1.5-2, alternatively 2-3, alternatively 3-4, alternatively 4-5, alternatively 5-7, alternatively 7-10, alternatively 10-15, alternatively 15-20, alternatively 20-25, alternatively 25-30, alternatively 30-40, alternatively 40-50, or any combinations of ranges thereof, or even higher than 50.

Referring again to FIGS. 1C and 1E, by ensuring that the SSE is adjacent to the lithium storage segment sidewalls in addition to the top surface, the SSE has access to a larger surface area of the lithium storage material. In operation, this may result in faster charging or discharging of the anode compared to a situation where the SSE is only in contact with the top surface of the lithium storage layer or segmented layer. The segmentation and increased surface area contact with the SSE may lessen other cycling stresses and increase cycle life.

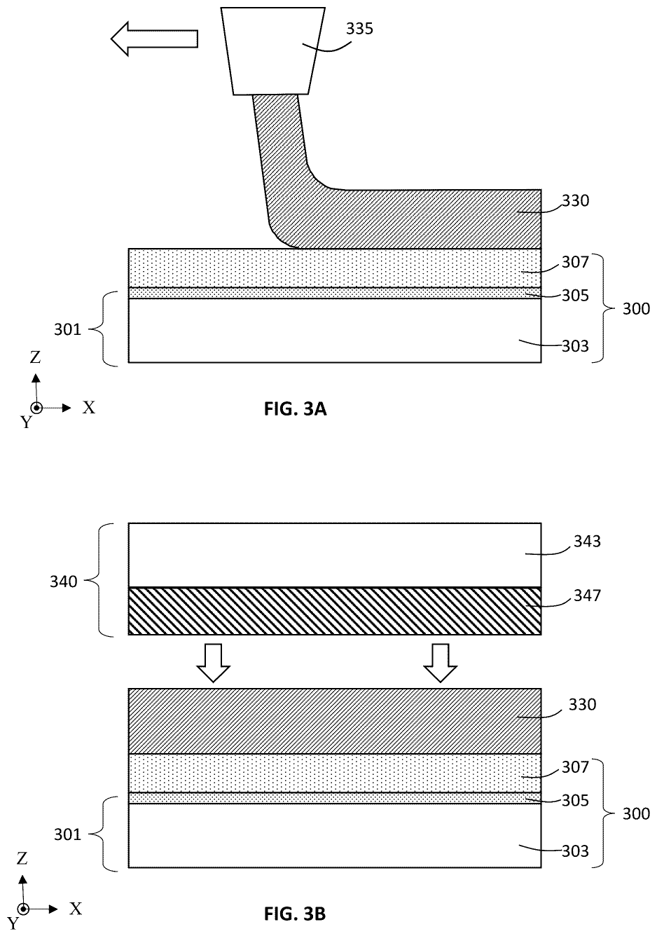

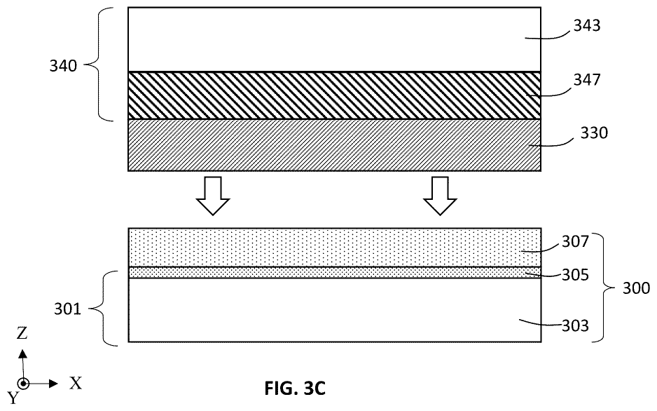

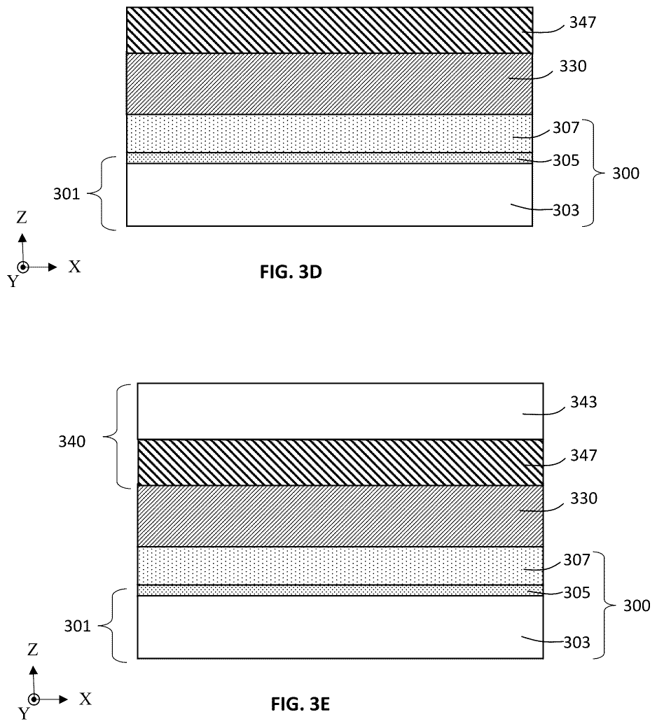

There are a number of methods available for making a precursor cell. FIGS. 3A and 3B are cross-sectional views illustrating a non-limiting example of making a precursor cell according to some embodiments. In FIG. 3A, SSE 330 may be extruded from an extruder that may include an extruder nozzle 335 onto anode 300. Anode 300 may include a current collector 301 that includes an electrically conductive layer 303 and a surface layer 305. Anode 300 further includes lithium storage layer 307 disposed over the current collector 301. The extruded SSE material may be in a relatively high flowability state at the nozzle. When the extruded SSE material meets the lithium storage layer, it may in some cases cool and transform into a lower flowability state. In some embodiments, the anode may optionally undergo active temperature control during extrusion. In some cases, the anode may be actively heated before, during, or after extrusion, e.g., so that the SSE may stay above its flow temperature. Alternatively, the anode may be actively cooled, e.g., so that the extruded SSE material rapidly drops below its flow temperature. In some cases, the extruded SSE material may include one or more solvents that evaporate or are driven off so that the SSE becomes less flowable after application on the anode.

In FIG. 3B, a cathode 340 having a cathode current collector 343 and cathode active material layer 347 may be laminated to the SSE 330. In particular, the surface of cathode active material layer 347 may be contacted with the upper surface of SSE 330. Such lamination may optionally include heat to improve adhesion of SSE 330 to the cathode active material layer 347. Such heating may optionally include temperature excursions that transform at least an interfacial portion of the SSE adjacent the cathode to a higher flowability state. Lamination may further include application of some pressure between the anode and cathode. In some embodiments, in addition to or instead of heating, a solvent material may be applied to soften at least the surface of SSE 330 to promote adhesion to the cathode active material layer 347.

In another embodiment of FIG. 3A, rather than extrusion, the SSE material may instead be coated from a mixture containing a solvent that is removed through drying. Part 335 may represent a coating head. Some non-limiting examples of coating processes may include gravure, slot die, spray, dip coat, inkjet, flexographic, rod, or blade coating methods. In some other embodiments, the SSE material may be a free-standing film laid over the anode and laminated thereto when laminating the cathode. In some cases, the SSE material may be transferred from a donor sheet.

FIG. 3C is a cross-sectional view of another non-limiting example of making a precursor cell according to some embodiments. Here, SSE layer 330 is first applied to cathode 340 having a cathode current collector 343 and a cathode active material layer 347 disposed between the cathode current collector 343 and SSE layer 330. This structure may then be laminated to anode 300, optionally at elevated temperature and/or elevated pressure to form a structure that may be similar to precursor cell 161 of FIG. 1A. Although not illustrated, a portion of the SSE layer may be applied to the cathode and a portion of the SSE layer may be applied to the anode followed by lamination of the two structures to form the precursor cell.

FIGS. 3D and 3E are cross-sectional views of another non-limiting example of making a precursor cell according to some embodiments. Referring to FIG. 3D, in a manner that may be similar to FIG. 3A, an SSE layer may be applied over a lithium storage layer 307 followed by deposition of cathode active material layer 347, e.g., from a slurry or by extrusion. Alternatively, layers 330 and 347 may be a free-standing bilayer film that has been laminated over the lithium storage layer. Referring to FIG. 3E, a cathode current collector 343 may be deposited (e.g., by physical vapor deposition of a conductive material or the like) or laminated (e.g., by laminating free-standing conductive material) to the structure from FIG. 3D.

Lamination methods may in some cases include nip rollers that may optionally be heated. Further, it should be appreciated that anodes and cathodes are often coated on both sides of their respective current collector with their respective battery-active material (e.g., a lithium storage layer for the anode and cathode active material for the cathode). Although the figures illustrate single-sided anode and cathode structures, similar teachings can be applied to anodes and cathodes coated on both sides of their respective current collectors.

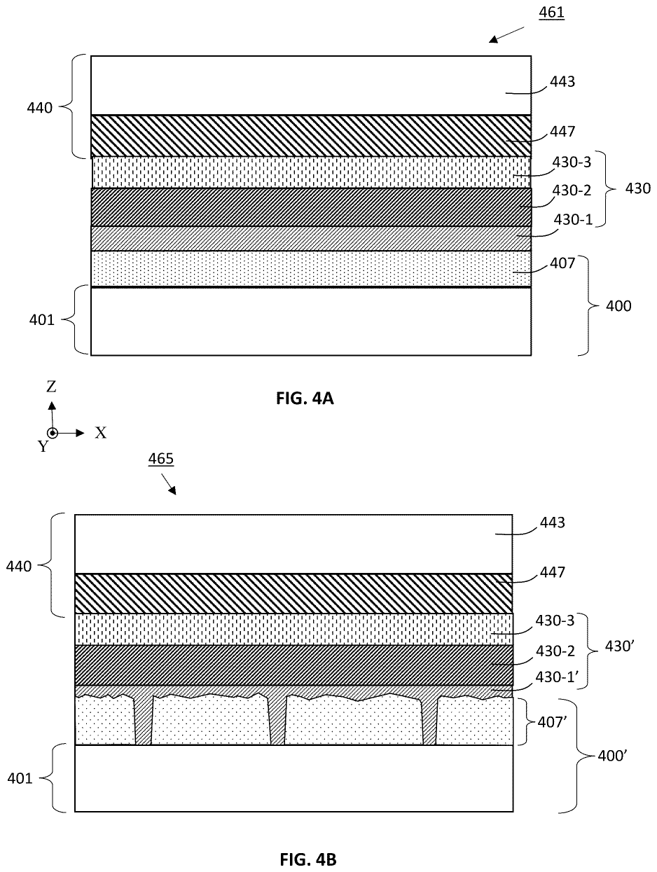

In some embodiments, the SSE may include two or more layers of different SSE materials. FIG. 4A is a cross-sectional view of a precursor cell 461 and FIG. 4B is a cross-sectional view of a corresponding lithium-ion battery cell 465 made from precursor cell 461. Precursor cell 461 includes anode 400, a cathode 440, and a solid-state electrolyte 430 disposed between the anode and the cathode. Anode 400 may include an anode current collector 401 and a lithium storage layer 407 in contact with the anode current collector.

Cathode 440 may include a cathode current collector 443 and a cathode active material layer 447 disposed in contact with the cathode current collector and facing the lithium storage layer 407.

The solid-state electrolyte 430 includes a multilayer structure. A first SSE layer 430-1 including a first SSE material is provided adjacent to the anode 400. A second SSE layer 430-2 including a second SSE material is interposed between the first SSE layer 430-1 and cathode 440. The first SSE material has a different chemical composition than the second SSE material. In some embodiments (as illustrated here), the multilayer structure may optionally include a third SSE layer 430-3 having a third SSE material interposed between the second SSE layer 430-2 and cathode 440. The third SSE material has a different chemical structure than the second SSE material. The third SSE material may also have a different chemical structure than the first SSE material, but in some other cases, the first and third SSE materials may be substantially the same with respect to chemical composition. The materials and properties of each SSE layer may be independently selected, and adjacent SSE layers are typically different in some way. Such properties may include, but are not limited to, thickness, elasticity, compressibility, viscosity, melting point, lithium-ion conductivity, electrical conductivity, lithium-ion concentration, lithium counterions, cross-linking agents, additives, chemical composition, compositional gradients, or the like. Unless otherwise noted herein, “substantially the same” may refer to when a relevant metric for a property is comparatively within about 10%, and “different” may refer to when a relevant comparative metric for a property is comparatively at least 10% higher or lower. An SSE material of any SSE layer may be independently selected to include a solid polymer electrolyte, a solid inorganic electrolyte, or a hybrid electrolyte, which are described elsewhere herein.

At least one of the SSE layers includes an SSE material that is reversibly transformable from a low flowability state (e.g., a glassy or solid state) below a temperature T₂ to a high flowability state (e.g., a fluid or liquid state) at or above a temperature Ti without degrading the desired properties of the SSE as discussed elsewhere herein. In some preferred embodiments, at least the first SSE material in the first SSE layer 430-1 is reversibly transformable. In some embodiments, the second or third, or both the second and third SSE materials are also reversibly transformable. In the embodiment of FIG. 4A, the first SSE layer 430-1 includes a solid polymer electrolyte that is reversibly transformable, but the materials of the second and third SSE layers are not reversibly transformable, at least under some conditions where the first SSE material can be reversibly transformable. In some cases, the second SSE layer 430-2 includes a solid inorganic electrolyte such as a solid sulfide or any other solid inorganic electrolytes discussed herein. The optional third SSE layer 430-3 may include a solid polymer electrolyte or a solid inorganic electrolyte (different from the second SSE layer) or a hybrid electrolyte.

In a manner similar to that described with respect to FIG. 1C, and with reference also to FIG. 4B, the precursor cell may undergo electrochemical treatment. During electrochemical treatment the precursor cell may be heated to a temperature Ti so that the first SSE material in the first SSE layer 430-1 is transformed to a high flowability state. Pressure may optionally be applied between the cathode and anode during the heating. During electrochemical treatment, the lithium storage layer 407 may reconstitute as a segmented lithium storage layer 407′ (part of anode 400′) as previously described. The heating allows the first SSE material, now in its high flowability state, to flow into spaces between the lithium storage segments to form a modified first SSE layer 430-1′, and overall, a modified SSE 430′. In some cases (as shown here), the second and third SSE layers stay in a low flowability state at temperature T₁. Upon cooling to below temperature T₂, the first SSE material transforms back from its high flowability state to a low flowability state, e.g., to become glassy or solid and lock in the structure of lithium-ion battery cell 465.

### Anode Current Collector

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the optional surface layer. If the tensile strength is too high or too low, it may in some cases be difficult to handle in manufacturing such as in roll-to-roll processes. During electrochemical cycling of the anode, deformation of the anode may occur if the tensile strength is too low, or alternatively, adhesion of the lithium storage layer may be compromised if the tensile strength is too high.

Deformation of the anode is not necessarily a problem for all products, and such deformation may sometimes only occur at higher capacities, i.e., higher loadings of lithium storage layer material. For such products, the current collector or electrically conductive layer may in some cases be characterized by a tensile strength Rm in a range of 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, alternatively 1200-1500 MPa, or any combination of ranges thereof.

In some embodiments, significant anode deformation should be avoided, but low battery capacities may not be acceptable. For example, in some cases when the anode includes 7 μm or more of amorphous silicon and/or the electrochemical cycling capacity is 1.5 mAh/cm² or greater, a current collector or electrically conductive layer may be selected that is characterized by a tensile strength Rm of greater than 450 MPa, alternatively greater than 500 MPa, alternatively greater than 550 MPa or alternatively greater than 600 MPa. In such embodiments, the tensile strength may be in a range of about 450-500 MPa, alternatively 500-550 MPa, alternatively 550-600 MPa, alternatively 600-650 MPa, alternatively 650-700 MPa, alternatively 700-750 MPa, alternatively 750-800 MPa, alternatively 800-850 MPa, alternatively 850-900 MPa, alternatively 900-950 MPa, alternatively 950-1000 MPa, alternatively 1000-1200 MPa, alternatively 1200-1500 MPa, or any combination of ranges thereof. In some embodiments, the current collector or electrically conductive layer may have a tensile strength of greater than 1500 MPa. In some embodiments, the current collector or electrically conductive layer is in the form of a foil having a tensile strength of greater than 600 MPa and an average thickness in a range of 4-8 μm, alternatively 8-10 μm, alternatively 10-14 μm, alternatively 14-18 μm, alternatively 18-20 μm, alternatively 20-25 μm, alternatively 25-30 μm, alternatively 30-40 μm, alternatively 40-50 μm, or any combination of ranges thereof.

In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. For anodes having low capacity and/or where there are no concerns regarding anode deformation during use, a wide variety of conductive materials may be used as the electrically conductive layer.

In some embodiments, the electrically conductive layer includes a metallic material, e.g., titanium (and its alloys), nickel (and its alloys), copper (and its alloys), or stainless steel. In some embodiments, even metals that may normally react or alloy with lithium, e.g., tin or aluminum, may be suitable if the surface layer is sufficiently protective. In some embodiments, the electrically conductive layer may include a multilayer structure, e.g., include multiple layers of metal. In some embodiments, the electrically conductive layer may be a clad foil. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil, a mesh, a fiber, a fabric, or sheet of conductive material. Herein, a “mesh” includes any electrically conductive structure having openings such as found in interwoven wires, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers, or carbon fiber or fabric.

When higher tensile strength is desirable, e.g., where Rm is greater than 450 MPa, alternatively greater than 500 MPa, alternatively greater than 550 MPa, or alternatively greater than 600 MPa, the electrically conductive layer may include nickel (and certain alloys), or certain copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous), CuNi3Si (an alloy primarily of copper, nickel, and silicon), CuCrZr (an alloy primarily of copper, chromium, and zirconium), and CuCrSiTi (an alloy primarily of copper, chromium, silicon, and titanium). The nomenclature for the metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

Alternatively, a mesh or sheet of electrically conductive carbon, including but not limited to, those formed from bundled carbon nanotubes or nanofibers, may in some cases provide for higher tensile strength electrically conductive layers. In some embodiments, an electrically conductive metal interlayer may be interposed between the electrically conductive carbon and the surface layer.

In some embodiments, any of the above-mentioned electrically conductive layers (low or high tensile strength) may act as a primary electrically conductive layer and further include an electrically conductive interlayer, e.g., a metal interlayer, disposed between the primary electrically conductive layer and the surface layer. For example, an electrically conductive layer may be similar to those described in PCT International Publication Number WO2022/005999, which is incorporated by reference herein in its entirety for all purposes.

The metal interlayer may be applied by, e.g., by sputtering, vapor deposition, electrolytic plating, or electroless plating, or any convenient method. The metal interlayer generally has an average thickness of less than 50% of the average thickness of the total electrically conductive layer, i.e., the combined thickness of primary electrically conductive layer and metal interlayer(s). In some embodiments, the surface layer may form more uniformly over, or adhere better to, the metal interlayer than to the primary electrically conductive layer.

### General Surface Roughness

In some embodiments, the current collector may be characterized as having a surface roughness. In some embodiments, and for example referring to FIG. 1B, the top surface 108 of the lithium storage layer 107 may have a lower surface roughness than the surface roughness of current collector 101. Herein, surface roughness comparisons and measurements may be made using the Roughness Average (Rₐ), RMS Roughness (R_{q}), Maximum Profile Peak Height roughness (Rₚ), Average Maximum Height of the Profile (R_{z}), or Peak Density (P_{c}). In some embodiments, the current collector may be characterized as having both a surface roughness R_{z}≥2.5 μm and a surface roughness Rₐ≥0.25 μm. In some embodiments, R_{z} is in a range of 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10μm, 10 to 12 μm, 12 to 14 μm or any combination of ranges thereof. In some embodiments, Rₐ is in a range of 0.25-0.30 um, alternatively 0.30-0.35 μm, alternatively 0.35-0.40 μm, alternatively 0.40-0.45 μm, alternatively 0.45-0.50 μm, alternatively 0.50-0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, alternatively 1.0-1.2 μm, alternatively 1.2-1.4 μm, or any combination of ranges thereof.

In some embodiments, some or most of the surface roughness of the current collector may be imparted by the electrically conductive layer and/or a metal interlayer. Alternatively, some or most of the surface roughness of the current collector may be imparted by the surface layer. Alternatively, some combination of the electrically conductive layer, metal interlayer, and surface layer may contribute substantially to the surface roughness.

In some embodiments, the electrically conductive layer may include roughening features, e.g., electrodeposited roughening features, to increase surface roughness. In some embodiments, the electrodeposited roughening features may include copper features. Current collector roughening features may in some cases take the form of nodules, hemispheroids, nanopillars, dendrites, or the like. In some cases, roughening features may be characterized by a height H extending from the electrically conductive layer and a maximum width. In some embodiments, roughening feature may be characterized by a height H in a range of about 0.1 μm to 0.2 μm, alternatively 0.2 μm to 0.4 μm, alternatively 0.4 μm to 0.6 μm, alternatively 0.6 μm to 0.8 μm, alternatively 0.8 μm to 1.0 μm, 1.0 μm to 1.5 μm, alternatively 1.5 μm to 2 μm, alternatively 2 μm to 3 μm, alternatively 3 μm to 4 μm, alternatively 4 μm to 5 μm, or any combination of ranges thereof. In some embodiments, roughening features may be characterized by a maximum width W in a range of about 0.1 μm to 0.2 μm, alternatively 0.2 μm to 0.4 μm, alternatively 0.4 μm to 0.6 μm, alternatively 0.6 um to 0.8 μm, alternatively 0.8 μm to 1.0 μm, 1.0 μm to 1.5 μm, alternatively 1.5 μm to 2 μm, alternatively 2 μm to 3 μm, or any combination of ranges thereof. In some cases, roughening features may be characterized by an aspect ratio H/W in a range of about 0.8 to 1.0, alternatively 1.0 to 1.5, alternatively 1.5 to 2.0, alternatively 2.0 to 2.5, alternatively 2.5 to 3, alternatively 3 to 4, alternatively 4 to 5, alternatively 5 to 6, alternatively 6 to 8, alternatively 6 to 10, or any combination of ranges thereof. In some embodiments, an average 10 μm by 10 μm surface of the electrically conductive layer may include at least 3 roughening features, alternatively at least 4, alternatively at least 5, alternatively at least 6, alternatively at least 7, alternatively at least 8, alternatively at least 9, alternatively at least 10.

Alternatively, or in combination with the roughening features, the electrically conductive layer may undergo another electrochemical, chemical, or physical treatment to impart a desired surface roughness prior to formation of the surface layer.

In some embodiments, roughening of the electrically conductive layer may include, for example, physical abrasion (such as sandpaper, sand blasting, polishing, or the like), ablation (such as by laser ablation), embossing, stamping, casting, imprinting, chemical treatments, electrochemical treatments, or thermal treatments. In some cases, such roughening may be used to form one or more of the roughening features described above, e.g., nodular features, nanopillar features, broad roughness features, pitted features or the like. In some cases, roughening features may be random, or alternatively, may be patterned.

### Surface Layer

In some embodiments, a surface layer may provide a chemical composition that promotes formation of an adherent lithium storage layer, such as a lithium storage layer deposited by a CVD or PVD process, particularly at commercially useful loadings or thicknesses of the lithium storage layer. In some cases, deposition onto an electrically conductive layer alone may be insufficient to provide even initial adhesion such that the lithium storage layer material readily brushes or peels off. Even when there is satisfactory initial adherence, it may be insufficient during electrochemical formation and cycling. Some non-limiting examples of surface layers are discussed below. In some cases, a surface layer may include two or more distinct surface sublayers having different chemical compositions. In some cases, a surface layer or even a surface sublayer may include a mixture of different surface layer materials.

The thickness of a surface layer may be as low as a monolayer in some embodiments. In some embodiments, the thickness of the surface layer is in a range of 0.0001 μm to 0.0002 μm, alternatively 0.0002 μm to 0.0005 μm, alternatively 0.0005 μm to 0.001 μm, alternatively 0.001 μm to 0.005 μm, alternatively 0.002 μm to 0.005 μm, alternatively, 0.005 μm to 0.01 μm, alternatively 0.01 μm to 0.02 μm, alternatively 0.02 μm to 0.03 μm, alternatively 0.03 μm to 0.05 μm, alternatively 0.05 μm to 0.1 μm, alternatively 0.1 μm to 0.2 μm, alternatively 0.2 μm to 0.5 μm, alternatively 0.5 μm to 1 μm, alternatively 1 μm to 2 μm, alternatively 2 μm to 5 μm or any combination of ranges thereof.

In some embodiments, the surface layer or sublayer may include a metal-oxygen compound. In some cases, a metal-oxygen compound may include a metal oxide or metal hydroxide, e.g., a transition metal oxide or a transition metal hydroxide. In some cases, a metal-oxygen compound may include an oxometallate, e.g., a transition oxometallate. In some embodiments, a surface layer may include a silicon compound including or derived from a siloxane, a silane (i.e., a silane-containing compound), a silazane, or a reaction product thereof. Herein, a “silicon compound” does not include simple elemental silicon such as amorphous silicon. These materials are described in more detail below. In some embodiments, a surface layer may include a silicate compound. In some embodiments, a surface layer may include a metal silicide, e.g., a transition metal silicide. In some embodiments, a surface layer may include a metal chalcogenide such as a metal sulfide, e.g., a transition metal sulfide.

### Metal-Oxygen Compounds

In some embodiments, the surface layer or a surface sublayer includes a metal-oxygen compound. The metal-oxygen compound may include an alkali metal, an alkaline earth metal, a transition metal, or a post transition metal. Unless otherwise noted, the term “transition metal” as used anywhere in the present application includes any element in groups 3 through 12 of the periodic table, including lanthanides and actinides. Metal-oxygen compounds may include metal oxides, metal hydroxides, oxometallates, or a mixture thereof. In some cases, the metal-oxygen compound may include a transition metal oxide, a transition metal hydroxide, a transition metal oxometallate, or a mixture thereof. In some embodiments, a metal interlayer may be provided between the electrically conductive layer and a surface layer that includes metal-oxygen compound. In some embodiments, the metal interlayer may be a transition metal. In some cases, the metal interlayer may include zinc, nickel, or an alloy of zinc and nickel. The interlayer may be considered part of the electrically conductive layer such that the metal interlayer is interposed between the surface layer and the rest of the underlying electrically conductive layer.

### Metal Oxides

In some embodiments, a surface layer or surface sublayer may include a metal oxide. In some embodiments, the metal oxide may include a transition metal oxide. In some embodiments, the metal oxide may include an oxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, a metal oxide may be an electrically conductive doped oxide, including but not limited to, indium-doped tin oxide (ITO) or an aluminum-doped zinc oxide (AZO). In some embodiments, the metal oxide may include an alkali metal oxide or alkaline earth metal oxide. In some embodiments the metal oxide may include an oxide of lithium. The metal oxide may include mixtures of metal oxides. For example, an “oxide of nickel” may optionally include other metal oxides in addition to nickel oxide. In some embodiments, a metal oxide includes an oxide of an alkali metal (e.g., lithium or sodium) or an alkaline earth metal (e.g., magnesium or calcium) along with an oxide of a transition metal (e.g., titanium, nickel, or copper). In some embodiments, the metal oxide may include some amount of hydroxide such that the ratio of oxygen atoms in the form of hydroxide relative to oxide is equal to or less than 1-to-1, respectively, alternatively less than 1-to-2, 1-to-3, or 1-to-4. The metal oxide may include a stoichiometric oxide, a non-stoichiometric oxide or both. In some embodiments, the metal within the metal oxide may exist in multiple oxidation states. Ordinarily, oxometallates may be considered a subclass of metal oxides. For the sake of clarity, any reference herein to “metal oxide” with respect to its use in a surface layer or sublayer excludes oxometallates unless otherwise stated.

In some embodiments, a surface layer or sublayer of metal oxide may be at least 1 monolayer in thickness, alternatively at least 2, 3, 5, or 10 monolayers. In some embodiments, a surface layer or sublayer having a metal oxide material may have an average thickness of at least 0.1 nm, alternatively at least 0.2 nm. In some embodiments, a surface layer or sublayer having a metal oxide material may have an average thickness of less than 5000 nm, alternatively less than 3000 nm. In some embodiments, a surface layer or sublayer having a metal oxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal oxide may be formed by atomic layer deposition (ALD), chemical vapor deposition (CVD), thermal vapor deposition, or sputtering. In some cases, a metal oxide may be formed by coating a suspension of metal oxide particles. In some embodiments, a metal oxide may be electrolytically deposited or electrolessly deposited (which may include “immersion plating”).

In some embodiments, a metal oxide precursor composition may be coated or printed over a current collector having one or more surface sublayers as described above and then treated to form the metal oxide. Some non-limiting examples of metal oxide precursor compositions include sol-gels (metal alkoxides), metal carbonates, metal acetates (including organic acetates), metal hydroxides and metal oxide dispersions. The metal oxide precursor composition may be thermally treated to form the metal oxide.

In some embodiments, the metal oxide precursor composition may include a metal, e.g., metal-containing particles or a sputtered metal layer. The metal may then be oxidized in the presence of oxygen (e.g., thermally), electrolytically oxidized, chemically oxidized in an oxidizing liquid or gaseous medium or the like to form the metal oxide.

### Metal Hydroxides

In some embodiments, a surface layer or surface sublayer may include a metal hydroxide. In some embodiments, the metal hydroxide may include a transition metal hydroxide. In some embodiments, the metal hydroxide may include a hydroxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium. In some embodiments, the metal hydroxide may include an alkali metal hydroxide or alkaline earth metal hydroxide. In some embodiments the metal hydroxide may include a hydroxide of lithium. The metal hydroxide may include mixtures of metal hydroxides. For example, a “hydroxide of nickel” may optionally include other metal hydroxides in addition to nickel hydroxide. In some embodiments, a metal hydroxide includes a hydroxide of an alkali metal (e.g., lithium or sodium) or an alkaline earth metal (e.g., magnesium or calcium) along with a hydroxide of a transition metal (e.g., titanium, nickel, or copper). In some embodiments, a metal hydroxide sublayer may include some amount of oxide such that the ratio of oxygen atoms in the form of oxide relative to hydroxide is less than 1-to-1, respectively, alternatively less than 1-to-2, 1-to-3, or 1-to-4. The metal hydroxide may include a stoichiometric hydroxide, a non-stoichiometric hydroxide or both. In some embodiments, the metal within the metal hydroxide may exist in multiple oxidation states.

In some embodiments, a surface layer or sublayer of metal hydroxide may be at least 1 monolayer in thickness, alternatively at least 2, 3, 5, or 10 monolayers. In some embodiments, a surface layer or sublayer having a metal hydroxide material may have an average thickness of at least 0.1 nm, alternatively at least 0.2 nm. In some embodiments, a surface layer or sublayer having a metal hydroxide material may have an average thickness of less than 5000 nm, alternatively less than 3000 nm. In some embodiments, a surface layer or sublayer having a metal hydroxide material may have an average thickness in a range of 0.1-0.2 nm, alternatively 0.2-0.5 nm, alternatively 0.5-1 nm, alternatively 1-2 nm, alternatively 2-5 nm, alternatively 5 to 10 nm, alternatively 10-20 nm, alternatively 20-50 nm, alternatively 50-100 nm, alternatively 100-200 nm, alternatively 200-500 nm, alternatively 500-1000 nm, alternatively 1000-1500 nm, alternatively 1500-2000 nm, alternatively 2000-2500 nm, alternatively 2500-3000 nm, alternatively 3000-4000 nm, alternatively 4000-5000 nm, or any combination of ranges thereof.

In some embodiments, the metal hydroxide may be formed by atomic layer deposition (ALD), chemical vapor deposition (CVD), thermal vapor deposition, or sputtering. In some cases, a metal hydroxide may be formed by coating a suspension of metal hydroxide particles. In some embodiments, a metal hydroxide may be electrolytically deposited or electrolessly deposited (which may include “immersion plating”).

In some embodiments, a metal hydroxide precursor composition may be coated or printed over a current collector having one or more surface sublayers as described above and then treated to form the metal hydroxide. Some non-limiting examples of metal hydroxide precursor compositions may include sol-gels (metal alkoxides), metal carbonates, metal acetates (including organic acetates) and metal oxide dispersions. The metal hydroxide precursor composition may be thermally treated, optionally in the presence of water or an alkaline aqueous medium to form the metal hydroxide.

In some embodiments, the metal hydroxide precursor composition may include a metal, e.g., metal-containing particles or a metal layer. The metal may then be oxidized in the presence of oxygen (e.g., thermally), electrolytically oxidized, chemically oxidized in an oxidizing liquid or gaseous medium or the like to form the metal hydroxide. Such oxidation may optionally be carried out in the presence of water or under alkaline conditions.

### Oxometallates

As noted previously, oxometallates herein are considered separately from other non-anionic metal oxides. Oxometallates may be considered a type of metal oxide where the metal oxide moiety is anionic in nature and is associated with a cation, which may optionally be an alkali metal, an alkaline earth metal, a transition metal, or even a post transition metal. In some embodiments, a transition oxometallate may include scandium, titanium, vanadium, manganese, iron, cobalt, nickel, copper, yttrium, zirconium, niobium, molybdenum, tantalum, or tungsten. In some embodiments, a transition oxometallate may include a chromate, tungstate, vanadate, or molybdate. In some embodiments, the surface layer or surface sublayer may include, or be formed from, a transition oxometallate other than chromate.

In some embodiments, an oxometallate may be formed by sputtering. In some cases, an oxometallate may be formed by coating a suspension or solution of oxometallate material or particles. In some embodiments, an oxometallate may be electrolytically plated or electrolessly plated (which may include “immersion plating”). In some embodiments, such electrolytic or electroless plating may use a solution including a transition oxometallate. In some cases, the nature of the deposited coating may include a mixture of transition metal oxide, hydroxide and/or oxometallate.

In some embodiments, the amount of a transition metal from a transition oxometallate in the surface layer or sublayer may be at least 0.5 mg/m², alternatively at least 1 mg/m², alternatively at least 2 mg/m². In some embodiments, the amount of the transition metal from a transition oxometallate is less than 250 mg/m². In some embodiments, the amount of the transition metal from a transition oxometallate may be in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-75 mg/m², alternatively 75-100 mg/m², alternatively 100-250 mg/m², or any combination of ranges thereof. In some embodiments, a surface layer or sublayer having an oxometallate material may be at least 0.2 nm thick, alternatively at least 0.5 nm thick, alternatively at least 1 nm thick, at least 2 nm thick. In some embodiments a surface layer or sublayer having an oxometallate material may have a thickness in a range of 0.2-0.5 nm, alternatively 0.5-1.0 nm, alternatively 1.0-2.0 nm, alternatively 2.0-5.0 nm, alternatively 5.0-10 nm, alternatively 10-20 nm, alternatively 20-50 nm, alternatively 50-100 nm, or any combination of ranges thereof.

A transition metallate generally refers to a transition metal compound bearing a negative charge. The anionic transition metal compound may be associated with one or more cations (a “transition metallate compound”), which may optionally be an alkali metal, an alkaline earth metal, ammonium, alkylammonium, another transition metal (which may be the same or different than the transition metal of the anionic transition metal compound), or some other cationic species. A transition oxometallate is a particular type of transition metallate. Besides transition oxometallates, some non-limiting examples of useful transition metallates may include sulfometallates, cyanometallates, and halometallates, which may be used singly or in combination, or in combination with oxometallates. Unless noted to the contrary, embodiments using a transition oxometallate may instead use a transition metallate.

### Silicon Compounds

In some embodiments, a surface layer or sublayer includes a silicon compound formed by treatment with a silane, a siloxane, or a silazane compound, any of which may be referred to herein as a silicon compound agent. As mentioned, a silicon compound or a silicon compound agent does not include silicate compounds. In some embodiments, the silicon compound agent treatment may increase adhesion to an overlying sublayer or to the lithium storage layer. In some embodiments, the silicon compound may be a polymer including, but not limited to, a polysiloxane. In some embodiments, a siloxane compound may have a general structure as shown in formula (1)

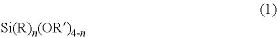

wherein, n=1, 2, or 3, and R and R′ are independently selected substituted or unsubstituted alkyl, alkenyl, or aryl groups.

The silicon compound of the layer or sublayer may be derived from a silicon compound agent but have a different chemical structure than the agent used to form it. In some embodiments, the silicon compound may react with the underlying surface to form a bond such as a metal-oxygen-silicon bond, and in doing so, the silicon compound may lose one or more functional groups (e.g., an OR′ group from a siloxane). In some embodiments, the silicon compound agent may include groups that polymerize to form a polymer. In some embodiments, the silicon compound agent may form a matrix of Si—O—Si cross links. In some embodiments, the PECVD deposition of a lithium storage material may alter the chemical structure of the silicon compound agent or even form a secondary derivative chemical species. The silicon compound includes silicon. The silicon compound may be the result of a silicon compound agent reacting with 1, 2, 3, or 4 reactants in 1, 2, 3, or 4 different reactions.

A silicon compound agent may be provided in a solution, e.g., at about 0.3 g/l to 15 g/l in water or an organic solvent. Adsorption methods of a silicon compound agent include an immersion method, a showering method and a spraying method and are not especially limited. In some embodiments a silicon compound agent may be provided as a vapor and adsorbed onto an underlying sublayer. In some embodiments, a silicon compound agent may be deposited by initiated chemical vapor deposition (iCVD). In some embodiments, a silicon compound agent may include an olefin-functional silane moiety, an epoxy-functional silane moiety, an acryl-functional silane moiety, an amino-functional silane moiety, or a mercapto-functional silane moiety, optionally in combination with siloxane or silazane groups. In some embodiments, the silicon compound agent may be a siloxysilane. In some embodiments, a silicon compound agent may undergo polymerization during deposition or after deposition. Some non-limiting examples of silicon compound agents include hexamethyldisilazane (HMDS), vinyltrimethoxysilane, vinylphenyltrimethoxysilane, 3-methacryloxypropyltrimethoxysilane, 3-glycidoxypropyltrimethoxysilane, 3-glycidoxypropyltriethoxysilane, 4-glycidylbutyltrimethoxysilane, 3-aminopropyltriethoxysilane, N-2-(aminoethyl)-3-aminopropyltrimethoxysilane, N-3-(4-(3-aminopropoxy) butoxy)propyl-3-aminopropyltrimethoxysilane, imidazolesilane, triazinesilane, 3-mercaptopropyltrimethoxysilane, 1,3,5,7-tetravinyl-1,3,5,7-tetramethylcyclotetrasiloxane, 1,3,5-trivinyl-1,3,5-trimethylcyclotrisiloxane, pentavinylpentamethylcyclopentasiloxane, and octavinyl-T8-silesquioxane. In some embodiments, a layer or sublayer including a silicon compound may include silicon, oxygen, and carbon, and may further include nitrogen or sulfur.

In some embodiments, treatment with a silicon compound agent may be followed by a step to drive off solvent or to initiate polymerization or another chemical transformation, wherein the step may involve heating, contact with a reactive reagent, or both. In some embodiments, a surface layer or sublayer formed using a silicon compound agent may have a silicon content in a range of 0.1 to 0.2 mg/m², alternatively in a range of 0.1-0.25 mg/m², alternatively in a range of 0.25-0.5 mg/m2, alternatively in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-100 mg/m², alternatively 100 -200 mg/m², alternatively 200-300 mg/m², or any combination of ranges thereof. In some embodiments, a surface layer or sublayer formed from a silicon compound agent may include up to one monolayer of the silicon compound agent or its reaction product, alternatively up to 2 monolayers; alternatively up to 4 monolayers, alternatively up to 6 monolayers, alternatively up to 8 monolayers, alternatively up to 10 monolayers, alternatively up to 15 monolayers, alternatively up to 20 monolayers, alternatively up to 50 monolayers, alternatively up to 100 monolayers, alternatively up to 200 monolayers. The surface layer or surface sublayer having the silicon compound may be porous. In some embodiments, the silicon compound may break down or partially breaks down during deposition of the lithium storage layer.

### Silicates

The surface layer may include a silicate compound. A silicate compound may include, or be formed from a solution containing, silicic acid or an anionic silicate species. Herein, an anionic silicate species is one that includes silicon and oxygen and is typically associated with an appropriate cationic moiety. In some cases, an anionic silicate species may be represented by formula (2)

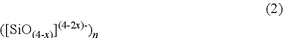

where 0≤x<2, and n≥1. In some case, the anionic silicate species may include [SiO₄]⁴⁻ (x=0, n=1, which may in some cases be referred to as an orthosilicate), [SiO₃]²⁻ (x=1, n=1, which may in some cases be referred to as a metasilicate), or [Si₂O₇]⁶⁻ (x=0.5, n=2, which may in some cases be referred to as a pyrosilicate). Anionic silicate species may in some cases include larger structures, such as polysilicates where n≤3.

In some embodiments, the associated cationic moiety may include a proton, a metal (“a metal silicate”), an alkylammonium moiety, or a mixture thereof. A metal silicate may include an alkali metal, an alkaline earth metal, a transition metal, a post-transition metal. In some embodiments a silicon compound may include a mixture of silicic acid and a metal silicate.

In some embodiments a surface layer may be formed by contacting a current collector precursor with a silicate treatment agent. The current collector precursor generally includes the electrically conductive layer and may optionally include one or more additional surface sublayers as discussed elsewhere herein. The silicate treatment agent may include, for example, an aqueous mixture (solution, dispersion, emulsion, or the like) that includes a silicate compound. In some cases, the silicate compound may have a water solubility of at least 10 ppm, alternatively at least 50 ppm, or alternatively at least 100 ppm. In some cases, the treatment agent may include silicic acid, a sodium silicate, a potassium silicate, or a mixture thereof. In some embodiments, the aqueous mixture may have a pH of at least 2, alternatively at least 4. In some embodiments, the aqueous mixture may have a pH in a range of about 4 to 5, alternatively 5 to 6, alternatively 6 to 7, alternatively 7 to 8, alternatively 8 to 9, alternatively 9 to 10, alternatively 10 to 11, alternatively 11 to 12, or any combination of ranges thereof.

In some cases, the silicate treatment agent may be provided as a bath into which the current collector precursor is immersed, or alternatively it may be spray applied or otherwise coated onto the current collector precursor. Contact with the silicate treatment agent may optionally include agitation such as bath circulation, sparging, stirring, movement of the current collector precursor, or the like. The silicate treatment agent may be at ambient temperature, or may be controlled, for example, in a temperature range of about 0° C.-5° C., alternatively 5° C.-10° C., alternatively 10° C.-15° C., alternatively 15° C.-20° C., alternatively 20° C.-25° C., alternatively 25° C.-30° C., alternatively 30° C.-40° C., 40° C. 50 ° C., alternatively 50° C.-60° C., alternatively 60° C.-80° C., or any combination of ranges thereof. In some cases, contact with the silicate treatment agent may be followed by a rinse with a rinsing agent. In some embodiments, the rinsing agent may include water, such as distilled water or tap water. A rinsing agent may optionally include other materials such as surfactants, dispersants, neutralizing materials, or some other material.

In some embodiments, the areal density of silicon from the silicate compound in the surface layer may be at least 0.2 mg/m², alternatively at least 0.5 mg/m². In some embodiments, the areal density of silicon from the silicate compound in the surface layer may be in a range of 0.2-0.5 mg/m², alternatively 0.5-1.0 mg/m², alternatively 1.5-2 mg/m², alternatively 2-3 mg/m², alternatively 3-5 mg/m², alternatively 5-7 mg/m², alternatively 7-10 mg/m², alternatively 10-15 mg/m², alternatively 15-20 mg/m², alternatively 20-30 mg/m², alternatively 30-50 mg/m², or any combination of ranges thereof.

### Metal Silicides

The surface layer may include a metal silicide. In some embodiments the metal silicide may have a chemical composition characterized by MₓSi_{y}, wherein M is a transition metal, x is the combined atomic % of one or more transition metals, y is the atomic % of silicon, and the ratio of x to y is in a range of about 0.25 to about 7. The ratio of x to y may vary within the metal silicide layer. In some embodiments, the surface layer may include metal silicide having a gradient in metal content, e.g., where the atomic % of the transition metal(s) decreases in the direction towards the lithium storage layer. When the ratio of x to y falls below 0.25, the silicon may in some embodiments be considered herein to be part of the lithium storage layer. When the ratio of x to y is above 7, the transition metal may be considered herein to be part of an electrically conductive layer. In some embodiments, M=Ti, V, Cr, Mn, Fe, Co, Ni, Cu, Zr, Mo, or W, or a binary or ternary combination thereof. The metal silicide may be stoichiometric or non-stoichiometric. The metal silicide layer may include a mixture of metal silicides having homogeneously or heterogeneously distributed stoichiometries, mixtures of metals, or both.

In some embodiments, the areal density of silicon from the metal silicide in the surface layer may be at least 0.2 mg/m², alternatively at least 0.5 mg/m². In some embodiments, the areal density of silicon from the metal silicide in the surface layer may be in a range of 0.2-0.5 mg/m², alternatively 0.5-1.0 mg/m², alternatively 1.5-2 mg/m², alternatively 2-3 mg/m², alternatively 3-5 mg/m², alternatively 5-7 mg/m², alternatively 7-10 mg/m², alternatively 10-15 mg/m², alternatively 15-20 mg/m², alternatively 20-30 mg/m², alternatively 30-50 mg/m², alternatively 50-100 mg/m², alternatively 100-200 mg/m², alternatively 200-300 mg/m², alternatively 300-400 mg/m², alternatively 400-500 mg/m², or any combination of ranges thereof.

In some embodiments, the metal silicide has an electrical conductivity of at least 10² S/m, alternatively at least 10³ S/m, alternatively at least 10⁴ S/m, alternatively at least 10⁵ S/m, alternatively at least 10⁶ S/m.

In some embodiments, the metal silicide may be formed prior to deposition of the lithium storage layer. For example, the metal silicide layer may be formed directly by atomic layer deposition (ALD), PECVD, or by a PVD process such as sputtering. Sputtering may use a single metal silicide sputter source or two sources, one for the metal and the other for silicon. In some embodiments, a slurry of metal silicide particles may be coated onto an electrically conductive layer and optionally dried or sintered. In some embodiments, the metal silicide layer may be formed by heating a metal layer (e.g., a metal part of the electrically conductive layer) that is in contact with a silicon layer.

### Lithium Storage Layer

In some embodiments, the lithium storage layer may be a porous material capable of reversibly incorporating lithium, e.g., continuous porous lithium storage layer. In some embodiments, the lithium storage layer includes silicon, germanium, antimony, tin, or a mixture of two or more of these elements. In some embodiments, the lithium storage layer is substantially amorphous. In some embodiments, a lithium storage layer includes substantially amorphous silicon. Such substantially amorphous storage layers may include a small amount (e.g., less than 20 atomic %) of crystalline material dispersed therein. The lithium storage layer may include dopants such as hydrogen, boron, phosphorous, sulfur, fluorine, aluminum, gallium, indium, arsenic, antimony, bismuth, nitrogen, or metallic elements. In some embodiments the lithium storage layer may include porous substantially amorphous hydrogenated silicon (a-Si:H), having, e.g., a hydrogen content of from 0.1 to 20 atomic %, or alternatively higher. In some embodiments, the lithium storage layer may include methylated amorphous silicon. Note that, unless referring specifically to hydrogen content, any atomic % metric used herein for a lithium storage material or layer refers to atoms other than hydrogen.

In some embodiments, the lithium storage layer, e.g., a continuous porous lithium storage layer, may include at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %. In some embodiments, a lithium storage layer, e.g., a continuous porous lithium storage layer, may include at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %, alternatively at least 98%, or alternatively at least 99%. Note that in the case of prelithiated anodes as discussed below, the lithium content is excluded from this atomic % characterization.

In some embodiments, the lithium storage layer, e.g., a continuous porous lithium storage layer, includes less than 10 atomic % carbon, alternatively less than 5 atomic %, alternatively less than 2 atomic %, alternatively less than 1 atomic %, alternatively less than 0.5 atomic %. In some embodiments, a lithium storage layer, e.g., a continuous porous lithium storage layer, is substantially free (i.e., the lithium storage layer includes less than 1 % by weight, alternatively less than 0.5 % by weight, alternatively less than 0.3% by weight, alternatively less than 0.1% by weight, alternatively less than 0.01% by weight) of carbon-based binders, graphitic carbon, graphene, graphene oxide, reduced graphene oxide, carbon black and conductive carbon. A few non-limiting examples of carbon-based binders may include organic polymers such as those based on styrene butadiene rubber, polyvinylidene fluoride, polytetrafluoroethylene, polyacrylic acid, carboxymethyl cellulose, or poly acrylonitrile.

The lithium storage layer, e.g., a continuous porous lithium storage layer, may include voids or interstices (pores), which may be random or non-uniform with respect to size, shape, and distribution. Such porosity does not result in, or result from, the formation of any recognizable lithium storage nanostructures such as nanowires, nanopillars, nanotubes, ordered nanochannels or the like. In some embodiments, the pores may be polydisperse. In some embodiments, the lithium storage layer, e.g., a continuous porous lithium storage layer, may be characterized as nanoporous. In some embodiments the lithium storage layer, e.g., a continuous porous lithium storage layer, has an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, alternatively 2.25-2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon, alternatively at least 97 atomic % silicon, alternatively at least 98 atomic % silicon, alternatively at least 99 atomic % silicon. Note that a density of less than 2.3 g/cm³ is evidence of the porous nature of a-Si containing lithium storage layers.

In some embodiments, the majority of active material (e.g., silicon, germanium or alloys thereof) of the lithium storage layer, e.g., a continuous porous lithium storage layer, has substantial lateral connectivity across portions of the current collector creating, such connectivity extending around random pores and interstices. Referring again to FIG. 1, in some embodiments, “substantial lateral connectivity” means that active material at one point X in the lithium storage layer 107 may be connected to active material at a second point X′ in the layer at a straight-line lateral distance LD that is at least as great as the average thickness T of the lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the continuous porous lithium storage layer may be described as a matrix of interconnected silicon, germanium or alloys thereof, with random pores and interstices embedded therein. In some embodiments, the lithium storage layer, e.g., a continuous porous lithium storage layer, may in a cross-sectional view have a sponge-like form. It should be noted that the lithium storage layer, e.g., a continuous porous lithium storage layer, does not necessarily extend across the entire anode without any lateral breaks and may include random discontinuities or cracks and still be considered continuous. In some embodiments, such discontinuities may occur more frequently on rough current collector surfaces. In some embodiments, the lithium storage layer, e.g., a continuous porous lithium storage layer, may in a cross-sectional view have abutting columns of active material such as silicon. The abutting columns may be characterized by an average height and average width, and generally have a height-to-width aspect ratio of less than 4:1, alternatively less than 3:1, alternatively less than 2:1, alternatively less than 1:1. Such abutting columns are laterally continuous. In some embodiments, the lithium storage layer, e.g., a continuous porous lithium storage layer, may include a matrix of connected nanoparticle aggregates. In some embodiments, the lithium storage layer may include a mixture of amorphous and crystalline silicon, e.g., nano-crystalline silicon having an average grain size of less than about 100 nm, alternatively less than about 50 nm, 20 nm, 10 nm, or 5 nm. In some cases, the lithium storage layer may include up to 30 atomic % nano-crystalline silicon relative to all silicon in the lithium storage layer.

In some embodiments, the lithium storage layer, e.g., a continuous porous lithium storage layer, includes a substoichiometric oxide of silicon (SiOₓ), germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof.

In some embodiments, the lithium storage layer, e.g., a continuous porous lithium storage layer, includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. Lithium storage layer having a substoichiometric nitride of silicon may also be referred to as nitrogen-doped silicon or a silicon-nitrogen alloy.

In some embodiments, the lithium storage layer, e.g., a continuous porous lithium storage layer, includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the continuous porous lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, a lithium storage layer such as a continuous porous lithium storage layer, e.g., a layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous continuous porous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, combinatorial PECVD and microwave sources may be used. In some embodiments, magnetron assisted RF PECVD may be used.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector. Example ranges for voltages and currents for the DC plasma source are 60 to 80 volts and 40 to 70 amperes, respectively.

Any appropriate silicon source may be used to deposit silicon. In some embodiments, the silicon source may be a silane-based precursor gas including, but not limited to, silane (SiH₄), dichlorosilane (H₂SiCl₂), monochlorosilane (H₃SiCl), trichlorosilane (HSiCl₃), silicon tetrachloride (SiCl₄), disilane, tetrafluorosilane, triethylsilane, and diethylsilane. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3-5, alternatively 5-10, alternatively 10-15, alternatively 15-20, or any combination of ranges thereof. In some embodiments, the gas flow ratio of hydrogen gas to silane is in a range of 0-0.1, alternatively 0.1-0.2, alternatively 0.2-0.5, alternatively 0.5-1, alternatively 1-2, alternatively 2-5, or any combination of ranges thereof. In some embodiments, higher porosity silicon may be formed and/or the rate of silicon deposition may be increased when the gas flow ratio of silane relative to the combined gas flows of silane and hydrogen increases. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001-0.0002, alternatively 0.0002-0.0005, alternatively 0.0005-0.001, alternatively 0.001-0.002, alternatively 0.002-0.005, alternatively 0.005-0.01, alternatively 0.01-0.02, alternatively 0.02-0.05, alternatively 0.05-0.10, or any combination of ranges thereof. Such gas flow ratios described above may refer to the relative gas flow, e.g., in standard cubic centimeters per minute (SCCM). In some embodiments, the PECVD deposition conditions and gases may be changed over the course of the deposition.

In some embodiments, the temperature at the current collector during at least a portion of the time of PECVD deposition is in a range of 20°°C. to 50° C., 50° C. to 100° C., alternatively 100° C. to 200° C., alternatively 200° C. to 300° C., alternatively 300° C. to 400° C., alternatively 400° C. to 500° C., alternatively 500°° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the lithium storage layer, e.g., a continuous porous lithium storage layer, depends on the storage material, desired charge capacity and other operational and lifetime considerations. Increasing the thickness typically provides more capacity. If the lithium storage layer becomes too thick, electrical resistance may increase and the stability may decrease. In some embodiments, the anode may be characterized as having an active silicon areal density of at least 0.2 mg/cm², alternatively at least 0.5 mg/cm², alternatively at least 1.0 mg/cm², alternatively at least 1.5 mg/cm², alternatively at least 3 mg/cm², alternatively at least 5 mg/cm². In some embodiments, the lithium storage structure may be characterized as having an active silicon areal density in a range of 0.2-0.5 mg/cm², alternatively in a range of 0.5-1.0 mg/cm², alternatively in a range of 1.0-1.5 mg/cm², alternatively in a range of 1.5-2 mg/cm², alternatively in a range of 2-3 mg/cm², alternatively in a range of 3-5 mg/cm2, alternatively in a range of 5-10 mg/cm², alternatively in a range of 10-15 mg/cm², alternatively in a range of 15-20 mg/cm², or any combination of ranges thereof. “Active silicon” refers to the silicon in electrical communication with the current collector that is available for reversible lithium storage at the beginning of cell cycling, e.g., after anode electrochemical formation. “Areal density” refers to the surface area of the electrically conductive layer over which active silicon is provided. In some embodiments, not all of the silicon content is active silicon, i.e., some may be tied up in the form of non-active silicides or may be electrically isolated from the current collector.

In some embodiments the lithium storage layer, e.g., a continuous porous lithium storage layer, has an average thickness of at least 0.5 μm, alternatively at least 1 μm, alternatively at least 2.5 μm, alternatively at least 5 μm, alternatively at least 6.5 μm. In some embodiments, the lithium storage layer, e.g., a continuous porous lithium storage layer, has an average thickness in a range of about 0.5 μm to about 50 μm. In some embodiments, the lithium storage layer, e.g., a continuous porous lithium storage layer, comprises at least 80 atomic % amorphous silicon and/or has a thickness in a range of 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

In some embodiments, rather than depositing the lithium storage material by CVD or PECVD, it may be formed by a physical vapor deposition (PVD) process such as by sputtering. Although the deposition rates of sputtering are typically lower than PECVD, sputtering may be suitable for some applications, e.g., those that require relatively lower loadings of the active material such as silicon. For example, in some embodiments, a lithium storage layer, e.g., a continuous porous lithium storage layer, formed by a sputtering process may have a thickness of less than about 15 μm, alternatively less than about 10 μm, alternatively less than 7 μm, alternatively less than 5 μm, alternatively less than 3 μm.

### Other Anode Features

The anode may optionally include various additional layers and features. The current collector may include one or more features to ensure that a reliable electrical connection can be made in the energy storage device. In some embodiments, a supplemental layer is provided over the lithium storage structure. In some embodiments, the supplemental layer is a protection layer to enhance lifetime or physical durability. In some embodiments, the supplemental layer may improve wetting of a liquid electrolyte, or alternatively, the coatability of the SSE to improve interfacial contact and/or cycling performance. The supplemental layer may be an oxide formed from the lithium storage material itself, e.g., silicon dioxide in the case of silicon, or some other suitable material. A supplemental layer may be deposited, for example, by ALD, S-ALD, CVD, i-CVD, PECVD, MLD, evaporation, sputtering, solution coating, ink jet or any method that is compatible with the anode. In some embodiments, the top surface of the supplemental layer may correspond to a top surface of the anode. In some embodiments, two or more supplemental layers may be used together.

A supplemental layer should be reasonably conductive to lithium ions, i.e., permit lithium ions to move into and out of the lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. In some embodiments, a supplemental layer may include an inorganic-organic hybrid structure having alternating sublayers of metal oxide and bridging organic materials such as so-called “metalcone” materials (e.g., zincone, titanicone, or zircone). The supplemental layer may include a lithium-containing material such as lithium phosphorous oxynitride (LIPON), lithium phosphate, lithium aluminum oxide, (Li,La)ₓTi_{y}O_{z}, or LiₓSi_{y}Al₂O₃ (where x, y, and z are not zero). The thickness of a supplemental layer may be in a range of 0.1-0.5 nm, alternatively 0.5-1.0 nm, 1-2 nm, 2-5 nm, 5-10 nm, 10-20 nm, 20-50 nm, 50-100 nm, or any combination of ranges thereof, or even in some cases thicker than 100 nm. The suitable thickness may depend in part on the lithium-ion conductivity of the supplemental layer. Preferably, the supplemental layer has a thickness of 100 nm or less.

In some embodiments, the lithium storage layer, e.g., a continuous porous lithium storage layer, may be at least partially prelithiated prior to a first electrochemical cycle after battery assembly, or alternatively prior to battery assembly. That is, some lithium may be incorporated into the lithium storage layer to form a lithiated storage layer even prior to a first battery cycle. In some embodiments, the lithiated storage layer may break into smaller structures, including but not limited to segments or platelets, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of 1% to 5% of the theoretical lithium storage capacity of the lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the lithium storage layer, e.g., a continuous porous lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the lithium storage layer.

In some embodiments, the lithium storage layer, e.g., a continuous porous lithium storage layer, includes at least 0.05 atomic % of one or more transition metals, alternatively at least 0.1 atomic %, alternatively at least 0.2 atomic %, alternatively at least 0.5 atomic %, alternatively at least 1 atomic % copper. In some embodiments, the lithium storage layer, e.g., a continuous porous lithium storage layer, includes less than about 10 atomic % of one or more transition metals, alternatively less than 5 atomic %, alternative less than 2 atomic %, alternatively less than 1 atomic %, alternatively less than 0.5 atomic %, alternatively less than 3 atomic %. In some embodiments, the lithium storage layer, e.g., a continuous porous lithium storage layer, may include one or more transition metals in an atomic % range of 0.05-0.1%, alternatively 0.1-0.2%, alternatively 0.2-0.5%, alternatively 0.5-1%, alternatively 1-2 %, alternatively 2-3%, alternatively 3-5%, alternatively 5-7%, alternatively 7-10%, or any combination of ranges thereof. In some embodiments, the aforementioned ranges of atomic % the transition metal(s) may correspond to a cross-sectional area of the lithium storage layer of at least 1 μm², which may be measured, e.g., by energy dispersive x-ray spectroscopy (EDS). In some embodiments, the transition metal atomic % values above may represent the atomic % of one transition metal or alternatively may correspond to the combined atomic % when there is mixture of transition metals. Some non-limiting examples of transition metals that may be present in the lithium storage layer include copper, nickel, titanium, vanadium, and molybdenum. In some embodiments, there is a gradient where the concentration of the transition metal in portions of the lithium storage layer near the current collector is higher than portions further from the current collector. In some embodiments, the lithium storage layer, e.g., a continuous porous lithium storage layer, may include a transition metal that is the same as a transition metal found in the electrically conductive layer or the surface layer transition metallate. In some cases, the one or more transition metals may be provided in the lithium storage layer by thermal treatments to cause migration of the metal into the lithium storage layer, but other methods may be used, such as co-deposition of the lithium storage material and the metal.

In some embodiments, thermally treating the anode may be done in a controlled environment having a low oxygen and water (e.g., less than 10 ppm or partial pressure of less than 0.1 Torr, alternatively less than 0.01 Torr content to prevent degradation). In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650°°C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, mesh or fabric.

### SSE

The solid-state electrolyte includes a source of mobile lithium ions that diffuse between the anode and the cathode (to the anode during charging and away from the anode during discharging). The three main families of SSE are solid polymer electrolytes (SPEs), solid inorganic electrolytes (SIEs), and hybrid SSE which uses both SPE and SIE materials. In some cases, the source of lithium ion may include a lithium salt, which may be in the form of a small molecule (e.g., LiTSFI, LiPF₆ or some any other lithium salt described below) suspended or dissolved in a SSE matrix. In some cases, a SPE material may include an anionic functional group that may act as the lithium salt counterion. The SSE may optionally include plasticizers, rheology control agents, or even a small amount of organic solvent(s).

A few non-limiting examples of polymeric materials that may be used in the SSE composition include poly(ethylene oxide) (PEO), poly(acrylonitrile) (PAN), poly(methyl methacrylate) (PMMA), poly(vinyl alcohol) (PVA), poly(trimethylene carbonate), diester-based polymers, PVdF-based polymers, polycaprolactone, and their derivatives or copolymers, which may be used alone or in combination. The polymer of the SSE may in some cases be cross-linked or branched. The polymer may be a block copolymer. A polymer SSE may be fully amorphous or include some crystallinity. The polymer may include anionic functional groups.

A few non-limiting classes of SIE material that may be used in the SSE composition include b-aluminas, LISICONs, thio-LISICONs, NASICONs, perovskites, antiperovskites, garnets, complex hydrides, and solid sulfides.

A few non-limiting classes of solid sulfides include ceramic sulfides, glass sulfides, and glass-ceramic sulfides. Glass sulfides show minimal long-range order that is identified by the lack of peaks in the pattern resulting from x-ray diffraction (XRD) measurements. Glass-ceramic sulfides include some glass structural regions and some regions with long range order that is identified by characteristic peaks in the pattern resulting from XRD measurements. Ceramic sulfides, also known as crystalline sulfides, are composed of regions that have long range order that is identified by characteristic peaks in the pattern resulting from XRD measurements. Non-limiting examples of ceramic sulfides include argyrodites, silicon thiophosphates, and silicon halide thiophosphates. Exemplary, but non-limiting, solid sulfides comprise a thiophosphate (PS₄) that may be identified by a characteristic feature in the pattern resulting from measurement with either infrared spectroscopy or Raman spectroscopy. Some additional examples of solid sulfides may include Li₆PS₅Cl, LGPS materials such as Li₁₀GeP₂S₁₂, and LPS materials such as Li—P₃S₁₁.

In some embodiments, under battery operating conditions, the SSE may have a lithium-ion conductivity in a range of 0.001 mS/cm to 0.01 mS/cm, alternatively in a range of 0.01 mS/cm to 0.1 mS/cm, alternatively in a range of 0.1 mS/cm to 1.0 mS/cm, alternatively higher than 1 mS/cm.

The thickness of the SSE needs to be sufficient to prevent shorting between the anode and cathode, but not so thick that it increases resistance or reduces energy density beyond desirable levels. An SSE generally has a thickness greater than 100 nm and less than 800 microns. For micro-batteries, it may be in a range of about 100 nm to 5 microns. For more conventional battery cells, the SSE may typically have a thickness in a range of 5-300 microns.

In some embodiments, the solid-state electrolyte includes a material reversibly transformable from a low flowability state to a high flowability state and back to a low flowability state. In some cases, this cycle may be available only once and such systems may be referred to as “singly reversible”. For example, an SSE in a first low flowability state may have a first chemical composition or morphology. After the high flowability state excursion, the SSE may revert to a second low flowability state and have a second chemical composition or morphology different from the first. For example, the SSE may undergo a polymerization or cross-linking reaction during or after the high flowability state to form the second low flowability state that is no longer as readily transformable to a high flowability state. In some other embodiments, the cycle may be repeatable two or more times (“multiply reversible”). In some cases, the low flowability state may correspond to a glassy state or a solid state. In some embodiments, a high flowability state may correspond to a liquid state. In some embodiments, a transformation from a low to high flowability state may approximately correspond to an SSE material's melting point, or alternatively, to a SSE material's glass transition temperature (Tg). In some embodiments, transformation from a low flowability state to a high flowability state may be accomplished by application of energy to the precursor cell so that the temperature of the SSE in the precursor cell is raised to T₁ where transformation can occur. The energy may be applied, for example, by placing the precursor cell in an oven or on a hot plate, exposure to a flash lamp, wrapping the cell in a heating coil, resistive heating of a precursor cell component, microwave exposure, or some other method. T_{1c} is generally above room temperature. In some embodiments, T₁ may be at least 40° C., alternatively, at least 50° C., 60° C., 80° C., 100° C., 125° C., 150° C., 175° C., or 200° C. In some embodiments, T₁ may be in a range of 40-60° C., alternatively in a range of 60-80° C., 80-100° C., 100-125° C., 125-150° C., 150-175° C., 175-200° C., 200-225° C., 225-250° C., or any combination of ranges thereof. In some embodiments, compression may be applied to the precursor cell (between the anode and cathode) while the SSE is in the high flowability state. Such compression may include a force of greater than 1 bar, alternatively greater than 1.5 bar, 2 bar, 3 bar, 4 bar, 5 bar, 7 bar, or 10 bar. In some cases, the compression is in a range of 1.1-1.5 bar, 1.5-2 bar, 2-3 bar, 3-4 bar, 4-5 bar, 5-7 bar, 7-10 bar, 10-15 bar, 15-20 bar, 20-30 bar, 30-50 bar, 50-75 bar, 75-100 bar, or any combination of ranges thereof.

In some embodiments, a high flowability state may be characterized by a viscosity lower than 1 MPa-sec, alternatively less than 500 kPa-sec, 200 kPa-sec, 100 kPa-sec, 50 kPa-sec, 20 kPa-sec, 10 kPa-sec, 5 kPa-sec, 2 kPa-sec, 1 kPa-sec, 500 Pa-sec, 200 Pa-sec, 100 Pa-sec, 50 Pa-sec, 20 Pa-sec, 10 Pa-sec, 5 Pa-sec, 2 Pa-sec, 1 Pa-sec, 0.5 Pa-sec, 0.2 Pa-sec, or 0.1 Pa-sec. In some cases, the high flowability state may be characterized by a viscosity in a range of 0.001-0.01 Pa-sec, alternatively 0.01-0.1 Pa-sec, 0.1-1 Pa-sec, 1-10 Pa-sec, 10-100 Pa-sec, 100-1000 Pa-sec, 1-10 kPa-sec, 10-100 kPa-sec, 100-500 kPa-sec, or any combination of ranges thereof.

A low flowability state has a higher viscosity than a high flowability state by at least a factor of 1.1×, alternatively by at least 1.5×, 2×, 5×, 10×, 20×, 50×, 100×, 200×, 500×, 1000×, 10⁴×, or 10⁵×. In some embodiments, a low flowability state may have a viscosity of at least 100 Pa-sec, alternatively at least 1 kPa-sec, alternatively at least 10 kPa-sec, alternatively at least 100 kPa-sec, alternatively at least 1 MPa-sec.

Transformation from the high flowability state to the low flowability state may include active cooling to T₂ (or below), e.g., using chillers, heat pumps, or the like to remove heat from the cell. Alternatively, passive cooling may be used where radiative cooling occurs, e.g., when room temperature is at or below T₂. In some cases, T₂ is less than T₁, e.g., T₂ may be 1-5° C. lower than T₁, or alternatively 5-10° C. lower, 10-20° C. lower, 20-30° C. lower, 30-40° C. lower, 40-50° C. lower, 50-75° C. lower, 75-100° C. lower, 100-150° C. lower, or any combination of ranges thereof, or even more than 150° C. lower.

### Cathode

Positive electrode (cathode) active materials include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn_{z}O₂, LiNi_{X}Co_{Y}Al_{Z}O₂, LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials may in some cases be mixed with one or more binders and coated to form the cathode. In some cases, the cathode may include polymeric electrolyte, SIE, or hybrid SSE materials like any of those described elsewhere, and which may be the same as or different than the material used in the SSE layer between the anode and cathode. In some cases, a solid electrolyte used in the cathode may be different than the SSE layer, e.g., it may have lower flowability than the SSE layer. Cathode active materials are typically provided on, or in electrical communication with, an electrically conductive cathode current collector.

### Battery Format

In some embodiments, batteries can be formed into multilayer stacks of anodes and cathodes, e.g., as in a pouch cell, a coin cell, or some prismatic cells. Alternatively, anode/cathode stacks can be formed into a so-called jelly-roll and used in a cylindrical cells or some prismatic cells. Such structures are provided into an appropriate housing having desired electrical contacts. A cell may sometimes include a compression system that applies a compressive force between the anode and the cathode. This may sometimes improve cycle life.

### Current Separator

Although not usually necessary when using an SSE, the battery may further include a separator (sometimes referred to as a “current separator”) between the anode and cathode. The current separator allows lithium ions to flow between the anode and cathode but prevents direct electrical contact, e.g., when the SSE is in a state of high flowability. Current separators are typically made in the form of a porous sheet of electrically insulative material. In some cases, separators are single layer or multilayer polymer sheets (e.g., based on polyolefins, PET, or PVDF). Separators may alternatively include glass materials, ceramic materials, a ceramic material embedded in a polymer, a polymer coated with a ceramic, or some other composite or multilayer structure, e.g., to provide higher mechanical and thermal stability. In some cases, a separator may have >30% porosity, low ionic resistivity, a thickness of ˜10 to 50 μm and high bulk puncture strengths.

### Lithium Salts

As mentioned, some SSEs may include one or more lithium salts. A SSE may include one or more of the following non-limiting examples: LiPF₆, LiBF₄, LiCIO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃ (iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl)imidazole), and combinations thereof. In some embodiments, the effective concentration of lithium ion in the SSE may be at least 0.3 M, alternatively at least 0.7M, alternatively at least 1 M, alternatively at least 1.5 M.

In some embodiments, the SSE may include a relatively small amount of organic solvent, e.g., for increasing lithium-ion conductivity or simply as a vehicle for adding lithium salts. In some embodiments, the weight % of solvent relative to other components of the SSE may be less than 10%, alternatively less than 5%, 2%, 1%, 0.5%, 0.2%, or 0.1%. If used at all, some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

In some embodiments, electrochemical cycling conditions may be set to utilize only a portion of the theoretical charge/discharge capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

### Embodiments Still further embodiments herein include the following enumerated embodiments.

1. A method for making a lithium-ion battery cell, the method including:
a) providing a precursor cell including:
i) an anode including a silicon-containing lithium storage layer deposited onto an anode current collector by a CVD or PVD process;
ii) a cathode including a cathode active material layer in contact with a cathode current collector; and
iii) a solid-state electrolyte (SSE) including lithium ions, the SSE interposed between silicon-containing lithium storage layer and the cathode active material layer;
b) electrochemically treating the precursor cell by applying at least a first voltage cycle between the anode and cathode to cause at least a partial charging of the anode, and subsequently, at least a partial discharging of the anode;
c) heating the precursor cell to a temperature T₁ of at least 40° C.; and
d) after the heating, cooling the cell to a temperature below T2 to produce the lithium-ion battery cell, wherein T2 is less than T1.

2. The method of embodiment 1, wherein the SSE is reversibly transformable between a low flowability state below T2 and a high flowability state at or above T1.

3. The method of embodiment 1 or 2, wherein the heating is conducted during the electrochemically treating.

4. The method of according to any of embodiments 1-3, wherein the heating is conducted after the electrochemically forming.

5. The method according to any of embodiments 1-4, wherein the electrochemically treating causes the lithium storage layer to separate into a plurality of lithium storage segments, and wherein the solid-state electrolyte flows into spaces between the plurality of lithium storage segments.

6. The method according to any of embodiments 1-5, wherein T₁ is at least 80° C., or optionally at least 100° C., or optionally at least 125° C., and wherein T₁ is less than 250° C.

7. The method according to any of embodiments 1-6, further including compressing the precursor cell between the anode and the cathode with a force greater than 10 bar.

8. The method according to any of embodiments 2-7, wherein the high flowability state is characterized by a viscosity of less than 10 kPa-sec.

9. The method according to any of embodiments 2-8, wherein the low flowability state is characterized by a viscosity of at least 100 kPa-sec.

10. The method according to any of embodiments 1-9, wherein the SSE includes a solid polymer electrolyte.

11. The method according to any of embodiments 1-10, wherein the SSE includes a solid inorganic electrolyte.

12. The method according to any of embodiments 1-11, wherein the SSE includes a small molecule lithium salt.

13. The method according to any of embodiments 1-12, wherein the lithium storage layer includes a continuous porous lithium storage layer.

14. The method according to any of embodiments 1-13, wherein the lithium storage layer includes at least 80 atomic % of amorphous silicon, or optionally at least 90 atomic % of amorphous silicon, or optionally at least 95 atomic % of amorphous silicon.

15. The method of embodiment 14, wherein the density of the lithium storage layer is in a range of 1.1 to 2.29 g/cm3.

16. The method according to any of embodiments 1-12, wherein the lithium storage layer includes up to 30% of nano-crystalline silicon.

17. The method according to any of embodiments 1-16, wherein the lithium storage layer includes columns of silicon nanoparticle aggregates.

18. The method according to any of embodiments 1-17, wherein the lithium storage layer has an average thickness of at least 4 μm, or optionally at least 7 μm, or optionally at least 10 μm.

19. The method according to any of embodiments 1-18, wherein the anode current collector includes an electrically conductive layer and a surface layer disposed between the electrically conductive layer and the lithium storage layer.

20. The method of embodiment 19, wherein the surface layer includes a metal oxide, an oxometallate, a metalcone, or a metal silicide.

21. The method according to any of embodiment 1-20, wherein the anode further includes a supplemental layer disposed between the lithium storage layer and the SSE, wherein the supplemental layer includes a material that is conductive to lithium ions.

22. The method of embodiment 21, wherein the supplemental layer includes a metal oxide, LiPON, lithium phosphate, lithium aluminum oxide, (Li,La)xTiyOz, or LixSiy Al2O3.

23. The method according to any of embodiments 1-22, further including applying at least a portion of the SSE to the anode prior to cell assembly.

24. The method according to any of embodiments 1-23, further including applying at least a portion of the SSE to the cathode prior to cell assembly.

25. The method according to any of embodiments 1-24, wherein the SSE includes i) a first SSE material provided in a first SSE layer disposed adjacent to the anode, and ii) a second SSE material provided in a second SSE layer interposed between the cathode and the first SSE layer, wherein the second SSE material has chemical composition different from the first SSE material.

26. The method of embodiment 25, wherein the first SSE material includes a solid polymer electrolyte.

27. The method of embodiment 25 or 26, wherein the second SSE material includes a solid inorganic electrolyte.

28. The method according to any of embodiments 25-27, wherein the first SSE material is reversibly transformable between a low flowability state below T2 and a high flowability state at or above T1.

29. The method according to any of embodiments 25-28, wherein the second SSE material maintains a low flowability state under conditions where the SSE material of the first SSE layer is in a high flowability state.

30. A lithium-ion battery cell produced by the method of any one of embodiments 1-29.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

1. A method for making a lithium-ion battery cell, the method comprising:
a) providing a precursor cell comprising:
i) an anode comprising a silicon-containing lithium storage layer deposited onto an anode current collector by a CVD or PVD process;
ii) a cathode comprising a cathode active material layer in contact with a cathode current collector; and
iii) a solid-state electrolyte (SSE) comprising lithium ions, the SSE interposed between silicon-containing lithium storage layer and the cathode active material layer;
b) electrochemically treating the precursor cell by applying at least a first voltage cycle between the anode and cathode to cause at least a partial charging of the anode, and subsequently, at least a partial discharging of the anode;
c) heating the precursor cell to a temperature T₁ of at least 40° C.; and
d) after the heating, cooling the cell to a temperature below T₂ to produce the lithium-ion battery cell, wherein T₂ is less than T₁.
wherein the electrochemically treating causes the lithium storage layer to separate into a plurality of lithium storage segments, and wherein the solid-state electrolyte flows into spaces between the plurality of lithium storage segments.

2. The method of claim 1, wherein the SSE is reversibly transformable between a low flowability state below T₂ and a high flowability state at or above T₁.

3. The method of claim 2, wherein the high flowability state is characterized by a viscosity of less than 10 kPa-sec.

4. The method of claim 3, wherein the low flowability state is characterized by a viscosity of at least 100 kPa-sec.

5. The method of claim 1, wherein the heating is conducted during the electrochemically treating.

6. The method of claim 1, wherein the heating is conducted after the electrochemically treating.

7. (canceled)

8. The method of claim 1, wherein T₁ is at least 100° C.

9. The method of claim 1, further comprising compressing the precursor cell between the anode and the cathode with a force greater than 10 bar.

10. The method of claim 1, wherein the SSE comprises a solid polymer electrolyte.

11. The method of claim 1, wherein the SSE comprises a solid inorganic electrolyte.

12. The method of claim 1, wherein the SSE comprises a small molecule lithium salt.

13. The method of claim 1, wherein the lithium storage layer comprises a continuous porous lithium storage layer.

14. The method of claim 1, wherein the lithium storage layer comprises at least 80 atomic % of amorphous silicon.

15-20. (canceled)

21. The method of claim 1, wherein the anode further comprises a supplemental layer disposed between the lithium storage layer and the SSE, wherein the supplemental layer comprises a material that is conductive to lithium ions.

22. (canceled)

23. The method of claim 1, further comprising assembling the precursor cell by applying at least a portion of the SSE to the anode.

24. The method of claim 1, further comprising assembling the precursor cell by applying at least a portion of the SSE to the cathode.

25. The method of claim 1, wherein the SSE comprises i) a first SSE material in a first SSE layer disposed adjacent to the anode, and ii) a second SSE material in a second SSE layer interposed between the cathode and the first SSE layer, wherein the second SSE material has a chemical composition different from the first SSE material.

26. The method of claim 25, wherein the first SSE material comprises a solid polymer electrolyte.

27. The method of claim 26, wherein the second SSE material comprises a solid inorganic electrolyte.

28. The method of claim 25, wherein during heating of the precursor cell to T₁, the first SSE material is in a high flowability state, and during cooling of the cell to below T₂, the first SSE material is in a low flowability state.

29. The method of claim 28, wherein during heating of the precursor cell to T₁, the second SSE material maintains a low flowability state and the first SSE material is in a high flowability state.

30. A lithium-ion battery cell produced by the method of claim 1.
